(19) United States
(12) Patent Application Publication
(10) Pub. No.: US 2011/0117836 A1
(43) Pub. Date: May 19, 2011

(54) SIGNAL TRANSMISSION CHANNEL

(75) Inventors: Yaqiong Zhang, Singapore Science Park II (SG); Xiaobing Sun, Singapore Science Park II (SG); Yugang Ma, Singapore Science Park II (SG)

(73) Assignee: SONY CORPORATION, Tokyo (JP)

(21) Appl. No.: 12/942,190

(22) Filed: Nov. 9, 2010

(30) Foreign Application Priority Data
Nov. 17, 2009 (SG) 200907690-2

(51) Int. Cl. H04B 7/24

(52) U.S. Cl. 455/39

(57) ABSTRACT

A signal transmission channel using a SIW between a transmitter and distant receiver. The SIW may include a MSL/SIW interface, be flexible, may use plug connections and/or may operate in a MMW band.

### FIELD OF THE INVENTION

The present invention relates to a signal transmission channel particularly though not solely to a flexible SIW signal transmission channel.

### BACKGROUND

The following abbreviations may be used in this specification:

MSL Microstrip lines

CPW Coplanar waveguides

PCB Printed Circuits Board

MMW Millimeter-wave

SIW Substrate integrated waveguide

LCP Liquid-Crystal Polymer

TEM Transverse ElectroMagnetic

There a various frequency bands in use for transmitting data. More recently the MMW band has become more popular because of free usage and high-bandwidth.

Conventional transmission lines, such as MSL and CPW, are used widely in planar PCB circuits. However, for MMW, MSL and CPW may suffer from high loss and interference with each other due to radiation. On the other hand, traditional metal waveguides may have lower insertion loss for MMW and low radiation. Unfortunately, the transition from traditional metal waveguide to integrated planar circuits may be complex and the metal waveguide may be bulky in size.

In order to achieve very compact planar circuits in MMW frequencies, a SIW has been used instead of traditional metal rectangular waveguides. Examples include MMW packaging, MMW SIW antennas and SIW filters.

### SUMMARY OF THE INVENTION

In general terms, the invention proposes that a SIW be used as a signal transmission channel between a transmitter and distant receiver. The SIW may include a MSL/SIW interface, be flexible, may use plug connections and/or may operate in a MMW band. This may have one or more advantages including:

(1) there may be no radiation even with bending of the SIW;
(2) easy plugging in/out;
(3) improved field-matching between the MSL-SIW;
(4) several SIW can be put or stacked together closely without interference each other to build multiple parallel propagation channels;
(5) very wideband, low insertion loss, high performance, By using a flexible substrate, the whole SIW will be bendable;
(6) the SIW can be rigid as well as flexible according to different substrate material to be chosen;
(7) also other frequency band applications; and/or
(8) low manufacturing cost.

In a particular expression of the invention, there is provided a signal transmission channel as claimed in claim 1 or claim 2.

### BRIEF DESCRIPTION OF THE DRAWINGS

One or more example embodiments of the invention will now be described, with reference to the following figures, in which:

FIG. 1 is a schematic of a prior art SIW structure fabricated using a PCB process;

FIG. 2 is a schematic of a MSL-SIW-MSL MMW signal transmission channel according to a first example embodiment;

FIG. 3 is a graph of simulation results of the first example embodiment;

FIG. 4a is a schematic of a plug in/out SIW connector structure according to a second example embodiment; and

FIG. 4b is a side view of the head2 connector in FIG. 4a; and

FIG. 5 is a graph of simulation results of the second example embodiment.

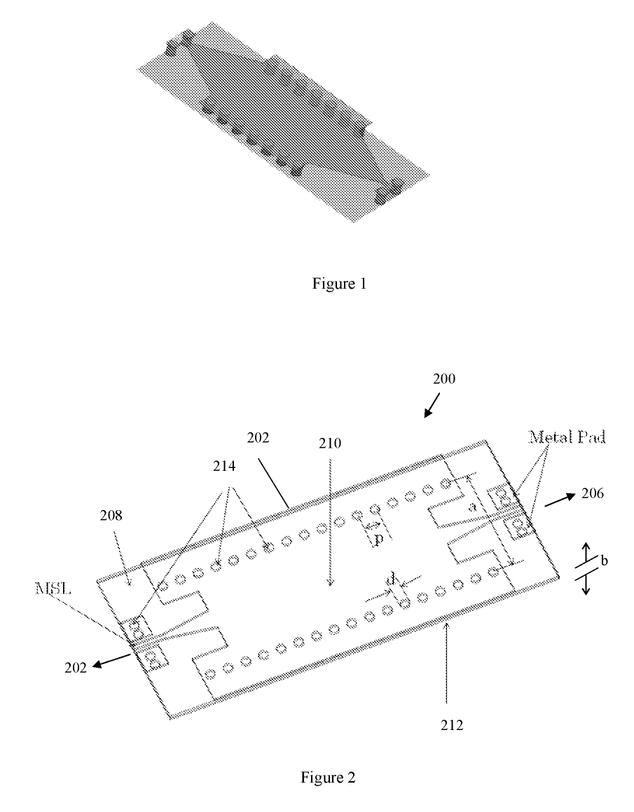

### DETAILED DESCRIPTION

According to the first example embodiment 200, MMW signals may be transmitted using a SIW structure 202 as the signal transmission channel as shown in FIG. 2. A flexible SIW structure is the preferred format. The SIW structure 202 may be permanently connected as a signal transmission channel between a transmitter 204 and a receiver 206.

The SIW structure 202 includes substrate material 208, top metal layer 210, bottom metal layer 212 and two rows of periodic via-hole connections 214 between the two metal layers 210, 212 structure. The SIW 202 is effectively a quasi-rectangular waveguide with dielectric material. The size of the SIW structure 202 may be approximately determined using dielectric filled rectangular metal waveguide theory.

As shown in FIG. 2, the width between via-holes is ‘a’. The diameter of the via-hole is ‘d’. The separate length between two via-holes in one row is ‘p’. The thickness of the substrate is ‘b’. Therefore, the cut-off frequency of SIWs' modes can be calculated in Equation 1:

$${f}_{Cmn} = \frac{1}{2 π \sqrt{μɛ}} \sqrt{{( \frac{m π}{a} )}^{2} + {( \frac{n π}{b} )}^{2}} \qquad ( 1 )$$

‘μ’ and ‘ε’ are the substrate's 208 permittivity and permeability where n and m are indexes for the different modes in each plane.

There may be only TEₙ₀ modes in the SIW structure 202 and the dominant mode may be TE₁₀ mode. So the cut-off frequency of the dominant TE₁₀ mode may be calculated in Equation 2:

$${f}_{Cmn} = \frac{1}{2 a \sqrt{μɛ}} \qquad ( 2 )$$

Thus the cut-off frequency of TE₁₀ mode may only be related to the width ‘a’ between via-holes. Thus the thickness ‘b’ of the substrate may not have much effect on TE₁₀ mode propagation in the SIW.

Typical design parameters to minimise the radiation loss and return loss in MMW are shown in Equation 3:

$$\frac{d}{p} \geq 0.5 \text{\&} \frac{d}{a} < 0.4 \qquad ( 3 )$$

The SIW may be fabricated on a flexible substrate, such as LCP, that may make the whole waveguide bendable and easy to use, for example Rogers 3003 or 4003. Various other materials are also possible depending on the application. The SIW may for example be 50-100 microns and 3 cm long.

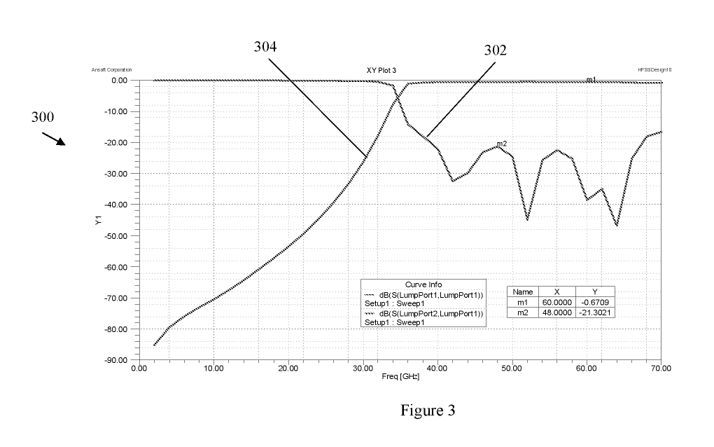

As shown in FIG. 3 the bandwidth 302 can be over several tens of GHz and the insertion loss 304 is less than 1 dB with total channel length equal to 8.8 mm.

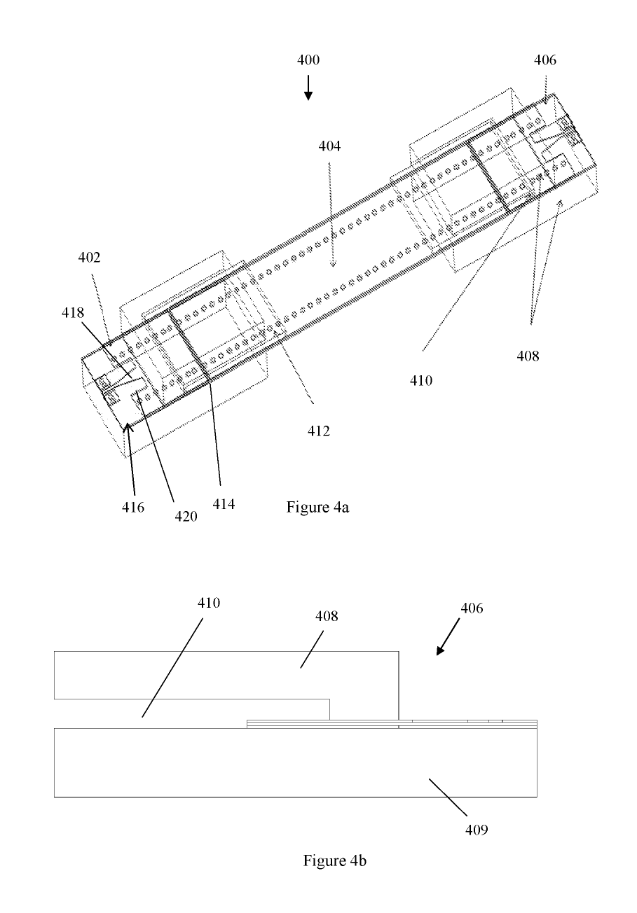

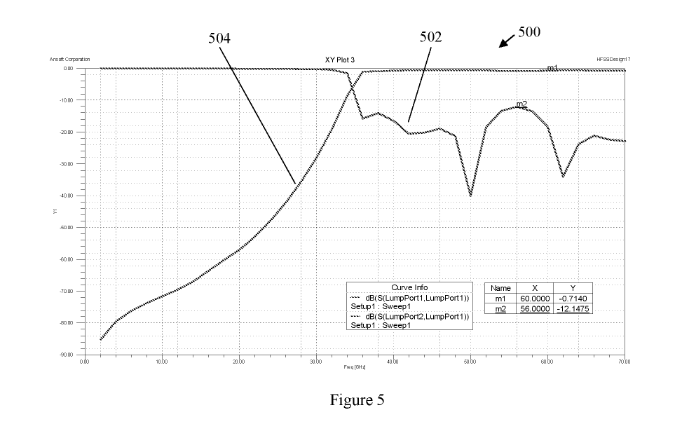

According to the second example embodiment 400, an easy plug in/out connector is provided for the SIW structure as shown in FIG. 4a. Whereas the first example embodiment may be permanently connected to between a receiver and transmitter, the second example embodiment allows for the SIW to be disconnected and reconnected.

In the second example embodiment the SIW 400 has three separate parts: head1 402, middle 404 and head2 406. The head1 402 and head2 406 are each permanently attached to a transmitter or receiver, separately. The middle 404 is chosen as an appropriate length to connect between head1 402 and head2 406. When the middle 404 is in place and connected, the transmission channel can be established again conveniently.

The head2 406 is shown in more detail in FIG. 4b. The head2 406 and is sandwiched between two sheaths 408,409 with an open slot 410 at one side. The two heads 402,406 may be permanently connected to a transmitter or a receiver. The sheaths 408,409 and may be attached by glue or other mechanical attachment, such as screws, to the SIW portion of each head.

Metal patches 412,413 cover and extend from both ends of the middle 404 part. Each end of the middle part 404 and the metal patches 412,413 plug into the slot 410. When the middle 404 is plugged in the slot 410, the metal patch 412 is electrically connected between the top metal layer of both the head2 406 and the middle 404. This ensures there is no gap between the top metal layer of the head2 406 and the middle 404, so that the current becomes coherent inside the SIW. Similarly the bottom sheath 409 may also be metal, and electrically connect between the bottom metal layer of both the head2 406 and the middle 404. The top sheath 408 may either be plastic or metal, since its main purpose is mechanical engagement with the middle 404. The middle 404 may be inserted from the side of the slot 410 or bent (to temporarily shorten it) and then inserted from the end of the slot 410.

The middle 404 may be fabricated on a flexible substrate material or a rigid substrate. Since the both top and bottom layers of the SIW 400 are metal, the electric field is in limited inside the substrate and there is almost no radiation when the SIW 400 is bent.

Typically the head1 402 and the head2 406 will be permanently connected to a transmitter or receiver. The transmitter or receiver will typically include a MSL type transmission channel. Thus the second embodiment includes a MSL-SIW interface 416. Because the MSL 416 transmits in TEM mode, part of the transmission medium is the air surrounding the MSL, opposite the ground plane. Thus the MSL may not efficiently transfer signals if it were covered by the sheath 408. Also an uncovered structure may be more convenient for connection to the transmitter or receiver connector. Thus desirably the bottom sheath 409 may extend to the end of the head2 406, whereas the top sheath 402 may extend just short of the MSL-SIW interface 416 so that it is uncovered. Alternatively if the top sheath 402 is a dielectric, it may cover the MSL-SIW interface 416.

The MSL-SIW interface 416 should impedance match and field match between the MSL and the SIW. Impedance matching may be established using MSL tapering 418. Field matching may be achieved using a rectangular slot 420 on the end of the top metal layer of SIW. This slot 420 surrounds the MSL tapering 418, reduces the leakage of the MSL 416 E-field and improves the E-field matching.

FIG. 4 shows the bandwidth 502 can be over several tens of GHz and the insertion loss 504 is less than 1 dB with total channel length equal to 8.8 mm.

While example embodiments of the invention have been described in detail, many variations are possible within the scope of the invention as will be clear to a skilled reader.

1. A signal transmission channel comprising:
a SIW signal transmission channel;
a first interface to a receiver MSL including a tapered portion and a slot surrounding the tapered portion; and
a second interface to a transmitter MSL including a tapered portion and a slot surrounding the tapered portion.

2. A signal transmission channel comprising:
a first connector to interface with a receiver MSL;
a second connector to interface with a transmitter MSL; and
a SIW removably connectable between the first connector and the second connector.

3. The signal transmission channel claimed in claim 1 or 2 wherein the SIW is flexible.

4. The signal transmission channel claimed in claim 3 wherein the SIW comprises a LCP substrate.

5. The signal transmission channel claimed in any one of the preceding claims wherein the channel is configured for MMW signals.

6. The signal transmission channel claimed in claim 2 wherein the SIW is attached to the first connector and/or the second connector via a sheath.

7. The signal transmission channel claimed in claim 6 wherein the SIW abuts the first connector and two sheaths sandwich the abutment.

8. The signal transmission channel claimed in claim 7 wherein one of the sheaths includes a slot into which the SIW is engaged.

9. The signal transmission channel claimed in claim 8 wherein the SIW further comprises a metal patch configured to electrically connect a signal conduction path between the SIW and the first connector and/or the second connector.
